(19) United States
(12) Patent Application Publication
(10) Pub. No.: US 2024/0331311 A1
(43) Pub. Date: Oct. 3, 2024

(54) Assistance for Visual Impairment in Augmented Reality

(71) Applicant: International Business Machines Corporation, Armonk, NY (US)

(72) Inventors: Guang Han SUI, Beijing (CN); Peng Hui JIANG, Beijing (CH); Jun SU, Beijing (CN); Su LIU, Austin, TX (US); Yu ZHU, Beijing (CN)

(21) Appl. No.: 18/191,532

(22) Filed: Mar. 28, 2023

(51) Int. Cl. G06T 19/00; G06F 3/04815; G06T 19/20

(52) U.S. Cl. CPC G06T 19/006; G06F 3/04815; G06T 19/20; G06T 2200/24

(57) ABSTRACT

Techniques are described with respect to a system, method, and computer program product for AR visual impairment assistance. An associated method includes analyzing an AR experience of a user; detecting at least one virtual object based on the analysis; generating a model of the at least one virtual object; receiving an AR command of the user; and modifying the model based on the AR command.

### BACKGROUND

This disclosure relates generally to computing systems and augmented reality, and more particularly to computing systems, computer-implemented methods, and computer program products configured to provide assistance for visual impairment in augmented reality.

Virtual reality, augmented reality, extended reality, and/or mixed reality systems provide traversable virtual environments that inherently require users to encounter and interact with virtual objects and other virtual elements superimposed within the virtual environments in a three-dimensional manner. The virtual objects may be presented in various shapes, sizes, distances, colors, etc. which may be difficult for viewing by visually impaired users, much less toggling/interacting with virtual objects in an efficient manner. Additionally, various current approaches to circumvent this, such as but not limited to virtual reality-based voice assistance systems and tactile gloves, are plagued with issues such as slow processing times and lack of user personalization. As a result, visually impaired users navigating and interacting with virtual environments is deficient at a practical and/or operational level.

### SUMMARY

Additional aspects and/or advantages will be set forth in part in the description which follows and, in part, will be apparent from the description, or may be learned by practice of the invention.

Embodiments relate to a method, system, and computer program product for augmented reality (AR) visual impairment assistance. In some embodiments, the computer-implemented method for AR visual impairment assistance comprises analyzing an AR experience of a user; detecting at least one virtual object based on the analysis; generating a model of the at least one virtual object; receiving an AR command of the user; and modifying the model based on the AR command.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual visually impaired assistance system environment, according to an exemplary embodiment;

FIG. 3 illustrates a block diagram showing an augmented reality module and an object modeling module of the virtual visually impaired assistance system of FIG. 1, according to an exemplary embodiment;

FIG. 4 illustrates a schematic diagram showing a detected virtual object within a virtual environment, as viewed through a computer-mediated reality device, according to an exemplary embodiment;

FIG. 5 illustrates a schematic diagram showing the detected virtual object within the virtual environment of FIG. 4 with a virtual object model applied by the object modeling module, as viewed through a computer-mediated reality device, according to an exemplary embodiment;

FIG. 6 illustrates a schematic diagram showing the virtual object model within the virtual environment of FIG. 5 with a thumbnail of the virtual object model of FIG. 5 applied by the object modeling module, as viewed through a computer-mediated reality device, according to an exemplary embodiment;

FIG. 7 illustrates a flowchart depicting a method for augmented reality (AR) visual impairment assistance, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for AR visual impairment assistance. Ordinarily, users of AR systems navigate virtual environments in which digital content is overlayed in the vicinity of users based on real-time video captured by computer-mediated reality devices. However, the digital content such as, but not limited to, virtual objects and associated virtual elements (e.g., textual and graphical annotations, etc.) may be difficult to interact with by users who are visually impaired due to virtual objects' static and unchanging designs, operational performance, etc., which are designed for a generic user and/or unspecified operating environment. Thus, the present embodiments have the capacity to improve the augmented reality experience for visually impaired users by providing mechanisms to modify virtual objects within virtual environments in a manner that allows visually impaired users to interact with the virtual objects in an optimized fashion. For example, the present embodiments render a model of a virtual object by applying sensory units to the model allowing visually impaired users to highlight, toggle, manipulate, etc. virtual objects within their peripheral.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. It should be noted that a VR environment may be provided by any applicable computing device(s) configured to support a VR, augmented reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, augmented reality is technology that enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes.

As described herein, a “virtual object” is any applicable type of multi-media (e.g., video, image, animation, hologram, music, and the like), avatar, structure (e.g., building, room, virtual space, etc.), sign, label, menu, sticker, brochure, product packaging, text, infographics, notification, etc. configured to be inserted within a virtual environment.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

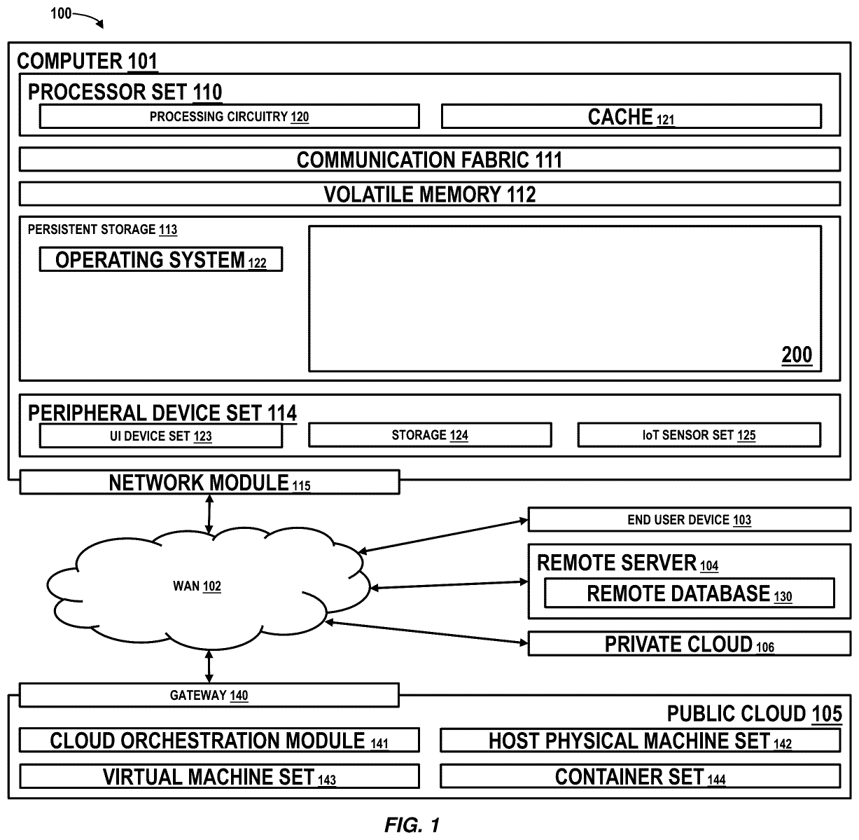

Referring now to FIG. 1, a computing environment 100 contains an example of an environment for the execution of at least some of the computer code involved in performing the inventive methods, such as virtual visually impaired assistance system 200. In addition to system 200, computing environment 100 contains an example of an environment for the execution of at least some of the computer code involved in performing the inventive methods.

Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

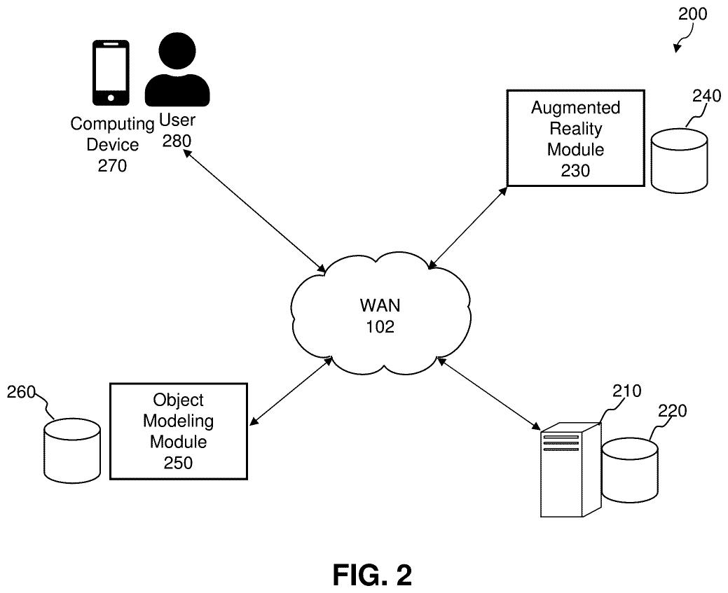

Referring now to FIG. 2, a functional block diagram of a networked computer environment illustrating a computing environment for a virtual visually impaired assistance system 200 (hereinafter “system”) comprising a server 210 communicatively coupled to a database 220, an augmented reality module 230 comprising an augmented reality module database 240, an object modeling module 250 comprising an object modeling module database 260, a computing device 270 associated with a user 280, each of which are communicatively coupled over WAN 102 (hereinafter “network”) and data from the components of system 200 transmitted across the network is stored in database 220.

In some embodiments, server 210 is configured to operate a centralized platform serving as a cloud-based augmented reality visually impaired assistance system that provides user 280 the ability to interact with virtual objects in virtual environments generated by augmented reality module 230 via accessing computing device 270 which supports user interfaces and application programming interfaces (APIs). In a preferred embodiment, the centralized platform is an augmented reality platform designed to allow user 280 to interact with virtual objects that have been processed and modeled by object modeling module 250. For example, a building structure off in the distance within the virtual environment may be difficult for user 280 to see in which object modeling module 250 models the building structure to be manifested in an interactive icon allowing user 280 to grab the interactive icon and hold it within their virtual hands for inspection and manipulation.

Augmented reality module 230 is tasked with not only receiving a plurality of sensor data, but also generating AR-based virtual environments (e.g., a virtual reality model of the scene/environment or superimposing virtual content over a real world view of the scene in augmented reality) based on the sensor data for presentation on computing device 270. Files and/or augmented reality-based data utilized to generate previous virtual environments are stored in augmented reality module database 240 allowing cognitive capability and/or other applicable cognitive based features to utilize data stored in augmented reality module database 240 for generating, modifying, and/or rectifying of virtual environments. In some embodiments, augmented reality module 230 may enable the automated generation and/or transformation of point clouds into virtual environments and augmented reality experiences overall. It should be noted that augmented reality module 230 may utilize various mechanisms and techniques known to those of ordinary skill in the art to present virtual content and may continuously update virtual environments and AR experiences based on real-time feedback of user 280 based on processing performed on the plurality of sensor data received by computing device 270.

Object modeling module 250 is configured to perform detection, analysis, modeling, modification, manipulation, etc. of virtual objects associated with virtual environments and AR experiences. It should be noted that a major purpose of object modeling module 250 is to perform detection of virtual objects and three-dimensional point cloud modeling of the virtual objects in order to perform various tasks such as rendering virtual object models, highlighting the virtual object models, assigning a plurality of sensory units to a virtual object model, generating thumbnails of the virtual object models, and enabling virtual interactions by user 280 with the virtual object models. Object modeling module 250 is configured to perform virtual object detection within a given virtual environment by analyzing the AR experience of user 280 presented on computing device 270, in which the virtual object detection may occur via one or more of image recognition/analysis, video recognition/analysis, multi-media parsing, computer visioning, or any other applicable augmented reality based image/video mechanism known to those of ordinary skill in the art. In some embodiments, object modeling module 250 may detect virtual objects based on analyzing augmented reality-based data stored in augmented reality module database 240. For example, upon comparing the current virtual environment to the previous renderings stored in augmented reality module database 240, object modeling module 250 ascertains that a new virtual object has been integrated into the virtual environment currently depicted to computing device 270.

In some embodiments, upon object modeling module 250 creating a three-dimensional model of a virtual object, object modeling module 250 assigns a plurality of sensory units to the model, in which the sensory units are configured to move in various directions subject to receiving virtual interactions from user 280. Sensory units may comprise sensors allowing user 280 to apply virtual interactions (e.g., touching/pressing, toggling, voice inputs, etc.) directly to a sensory unit resulting in a reaction from the model, in which a reaction may include, but is not limited to, movement, zooming in, zooming out, reading out of virtual object information (e.g., location, color, context, etc.), accessing of augmented reality module database 240, and the like.

Computing device 270 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database. It should be noted that in a preferred embodiment, user 280 is a visually impaired user donning a computer-mediated reality device such as, but not limited to, a virtual headset, virtual goggles, virtual glasses, or any other applicable computing device configured to support virtual reality, augmented reality, extended reality, and/or mixed reality systems.

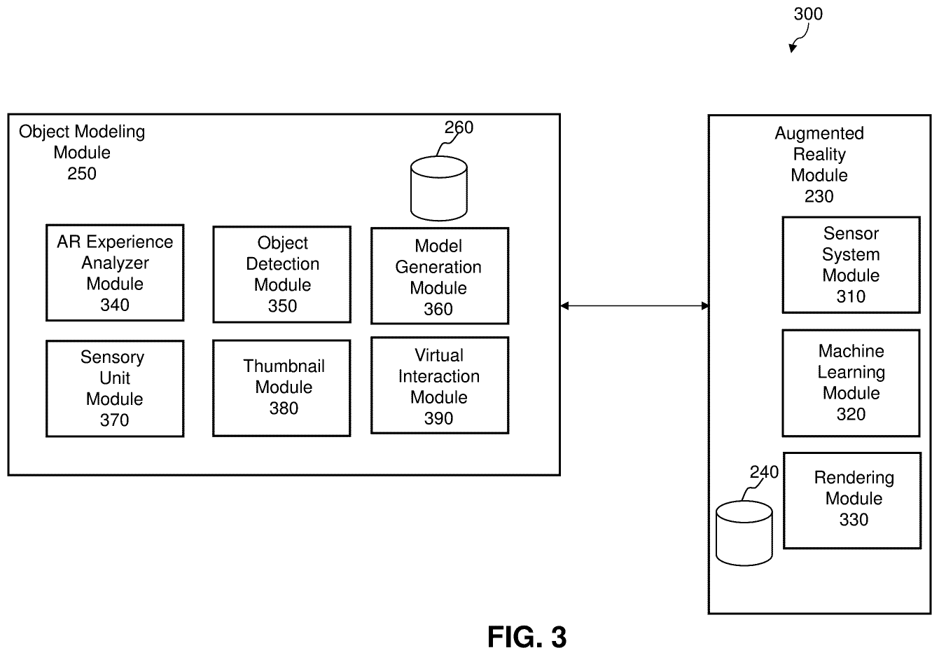

Referring now to FIG. 3, an example architecture 300 of augmented reality module 230 and object modeling module 250 is depicted, according to an exemplary embodiment. In some embodiments, augmented reality module 230 comprises a sensor system module 310, a machine learning module 320, and a rendering module 330, each of which is configured to applicable data in augmented reality module database 240. Object modeling module 250 comprises AR experience analyzer 340, an object detection module 350, a model generation module 360, a sensory unit module 370, a thumbnail module 380, and a virtual interaction module 390, each of which is configured to store applicable data in object modeling module database 260.

Sensor system module 310 is a collection of one or more sensor systems of augmented reality module 230 designed to collect sensor data for the purpose of analyzing, mapping, and rendering AR experiences and virtual environments of said AR experiences. The one or more sensor systems may include, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art. Sensor system module 310 may further collect sensor data from computing device 270 allowing tracking and monitoring of various data associated with user 280 including, but not limited to activity history, body movements, eye/gaze tracking, length of time of AR experiences, virtual environment analytics, virtual object interaction analytics, and the like.

Machine learning module 320 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In some embodiments, machine learning module 320 operates one or more machine learning models configured to utilize training datasets derived from one or more of database 220, augmented reality module database 240, object modeling module database 260, in which the one or more machine learning models are configured to generate outputs representing predictions associated with user 280, virtual environments, and/or virtual objects. For example, the one or more machine learning models may output predictions pertaining to placement of sensory units on a model of a virtual object generated by object modeling module 250.

Rendering module 330 is tasked with not only rendering the virtual environments of the AR experiences presented to computing device 270, but also visualizing and maintaining the model of the virtual object presented to user 280. Rendering module 330 may also generate interactive thumbnails (hereinafter “thumbnails”) of a plurality of frames derived from the AR experience by AR experience analyzer module 340. In some embodiments, the model performs one or more actions based upon the virtual interaction that is received at the applicable sensor of the applicable sensory unit. It should be noted that the rendering of the model and its responses at sensory units based upon mapping functions maintained by rendering module 330. For example, certain sensor units may be mapped to certain reactions due to one or more rules applied to the sensory unit determined by sensory unit module 370. The underlying purpose of this limitation is to prevent the changing of models when a change to a sensory unit occurs too rapidly, and thus, impacting the AR experience of the visually impaired. Inherently, AR experiences may change rapidly subject to the movements of user 280 in which the virtual environment is continuously modified in real-time; however, this may create a difficult AR experience for visually impaired users due to the fact that they require more time to interact with the virtual environment and virtual objects within. Thus, rendering module 330 maintaining the model and rendering the reactions to received inputs at the sensors of the respective sensory inputs reduces the amount of the difficulty associated with the AR experience by reacting to rules applied to the sensory units. Furthermore, sensory unit module 370 may modify sensory units of virtual objects models based on a detected change to the AR experiences, such as but not limited to change of the view of user 280 within the virtual environment, changing of user AR command applied to the virtual object model, delay in interaction with virtual object model for a predetermined amount of time, specific user gestures (e.g., hand swipe, head nod, blinking, etc.), and the like.

AR experience analyzer module 340 is designed to analyze AR experiences presented to computing device 270. One of the purposes of analyzing AR experiences in real-time is to not only continuously update augmented reality module database 240, but also to allow AR experience analyzer module 340 to capture screenshots and/or frames of the AR experience to optimize the rendering of the virtual object models, the rendering of thumbnails of the frames, and interactions with the frames. AR experience analyzer module 340 may utilize cognitive/analytic systems, image/video detection mechanisms, natural language processing (NLP), linear discriminant analysis (“LDA”), parsing functions, etc. in order to capture the plurality of frames of the AR experience, in which the plurality of frames may be utilized by object detection module 350 on a frame-by-frame basis in order to optimize detection and analysis of virtual objects.

Object detection module 350 is designed to identify virtual objects within virtual environments. In some embodiments, object detection module 350 identifies the virtual objects utilizing cognitive systems, image detection techniques, etc. while simultaneously extracting various information associated with the virtual objects including, but not limited to, classification/annotation of the virtual object, location data of the virtual object within the virtual environment, estimated distance of virtual object from a predetermined reference point within the virtual environment (i.e., current position of user 280 in the virtual environment), and the like. Object detection module 350 may communicate with machine learning module 320 in order to utilize a deep Convolutional Neural Network (CNN) to effectively identify virtual objects within the frames of the AR experience.

Model generation module 360 is tasked with generating the models of the virtual objects detected by object detection module 350. In particular, model generation module 360 generates a model of multi-dimensional virtual objects in the virtual environment by using 3D reconstruction data derived from AR experience analyzer module 340 (e.g., images, video stream, sensor data, etc.) and object detection module 350 in order to generate a 3D point cloud of the virtual object. The 3D point cloud may be used for tracking in AR application, by matching points from the cloud to regions in the live video. Model generation module 360 is further tasked with providing techniques that facilitate automatic, reliable performance of a point cloud object-environment segmentation task in order to render the virtual object model. For example, model generation module 360 may provide the capability to perform automatic segmentation of a 3D point cloud into object and virtual environment segments by progressively learning the object-environment segmentation from tracking sessions in augmented reality (AR) applications associated with the centralized platform stored in augmented reality module database 240. Model generation module 360 may utilize binary segmenting, fuzzy segmenting, object detection/tracking, and/or any other applicable 3D point cloud reconstruction related technology known to those of ordinary skill in the art.

Sensory unit module 370 is tasked with allocating the sensory units to the virtual objects. It should be noted that each of the sensory units is associated with a sensor in which the sensor is configured to receive inputs associated with user 280 referred to as virtual interactions, in which said inputs may include but are not limited to user 280 pressing down on the sensory unit, user 280 performing a physical gesture (e.g., head nod, swipe motion, etc.), user 280 emitting a voice-command (e.g., zoom in/out utterance, etc.), or any other applicable virtual interaction known to those of ordinary skill in the art. Sensory unit module 370 applies one or more rules to the sensory units in which the rules determine not only the virtual interaction that respective sensory units require, but also the reactions that a sensory unit supports which are initiated by the virtual interaction. Reactions as described herein includes, but is not limited to, zooming in, zooming out, shaking, electrification, or any other applicable AR reaction known to those of ordinary skill in the art. In some embodiments, sensory unit module 370 is configured to apply a sensory threshold to the sensory units, in which the virtual interaction does not initiate the applicable reaction unless the sensory threshold is exceeded. The purpose of the sensory threshold is to prevent switching and/or moving of the sensory unit allowing virtual object models to be ignored in order to prevent user 280 from getting lost in the virtual environment while focusing on a particular virtual object model.

Thumbnail module 380 is configured to generate the thumbnails derived from the plurality of frames associated with the AR experience. Thumbnails not only serve as a representation of a frame allowing user 280 to explore the frame at a granular level, but also supports user 280 interacting with a representation of the virtual environment in one hand while simultaneously interacting with a separate virtual object model in the other hand within the virtual environment. In some embodiments, a thumbnail may comprise multiple virtual object models due to object detection module 350 identifying multiple virtual objects within a frame, in which user 280 may navigate from one virtual object to the next by applying AR commands in the vicinity of the virtual object being viewed by user 280. In some embodiments, once one virtual object model in a thumbnail is touched, the corresponding sensory unit for the whole frame will notify user, and vice versa; thus, duality is provided to a visually impaired user by allowing them to view and interact with virtual environments and virtual objects simultaneously at a granular level.

Virtual interaction module 390 is tasked with applying virtual interactions to the sensory units of the virtual object models. It should be noted that virtual object models are configured to be inserted and closely examined in the hands of user 280 within the virtual environment, which allows the virtual interactions to initiate the reactions intended to be viewable by the visually impaired. In some embodiments, virtual interaction module 390 may apply a highlighting feature to a virtual object based upon the applicable virtual interaction received at the applicable sensory unit, in which the edges of the virtual object are highlighted. Upon the edges being highlighted, the reactions may be applied to the highlighted edges enticing the attention of user 280 along with providing user 280 the opportunity to interact with the applicable sensory unit in the vicinity of the highlighted edges. As previously mentioned, virtual interactions may include but are not limited to user 280 touching/pressing, toggling, providing voice inputs, virtual keyboard entries, and the like at the location of the applicable sensory input. In some embodiments, highlighting of the applicable edge of the virtual object model results in allocation of the sensory units to the virtual object, or the highlighting of the edge is rendered by the sensory units based on a received AR command associated with the virtual interaction, in which the sensory unit receives the AR command directly. For example, while interacting with a virtual object model in a hand of user 280, user 280 may utter “zoom in” at a sensory unit resulting in virtual interaction module 390 highlighting the edge associated with applicable location of the sensory unit and zooming in on said location.

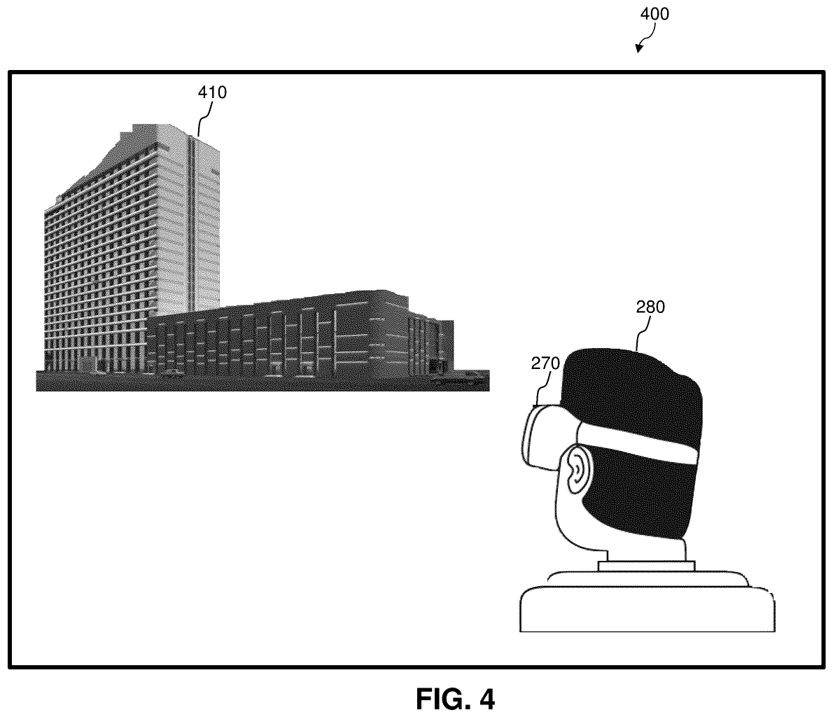

Referring now to FIG. 4, a virtual environment associated with an augmented reality experience 400 presented to computing device 270 is depicted, according to an exemplary embodiment. As illustrated, user 280 immersed in the virtual environment attempts to focus on a virtual object 410 (i.e., a building structure) located off in the distance of user 280; however due to their visual impairment and the distance this task is met with extreme difficulty. Simultaneously, AR experience analyzer 340 analyzes AR experience 400 by dynamically analyzing the applicable video and/or image of AR experience 400 resulting in object detection module 350 identifying virtual object 410 and subsequently classifying virtual object 410 as a virtual object requiring modeling by model generation module 360. In some embodiments, AR experience analyzer 340 parses the real-time video/image being presented to computing device 270 into a plurality of frames optimizing the identification of virtual objects via object detection module 350 by continuously scrutinizing the AR experience 400 on a frame-by-frame basis while progressively updating object modeling module database 260 with applicable data associated with virtual object 410. For example, as object detection module 350 is analyzing the frames, object detection module 350 is communicating with machine learning module 320 allowing categorization of virtual object 410 as a building structure and calculating the distance between user 280 and virtual object 410 by machine learning module 320 applying artificial intelligence machine learning model techniques, such as a reinforcement learning model, to provide applicable data associated with virtual object 410 to be stored in object modeling module database 260 and AR experience 400 to be stored in augmented reality module database 240. It should be noted that due to difficulty of virtual object 410 being viewed and/or interacted with by user 280, object detection module 350 instructs model generation module 360 to begin the modeling process of virtual object 410; however, in various embodiments, said instructions may be triggered by various occurrences including but not limited to computing device 270 detecting squinting, pausing for a predetermined amount of time, receiving an applicable linguistic input, and the like.

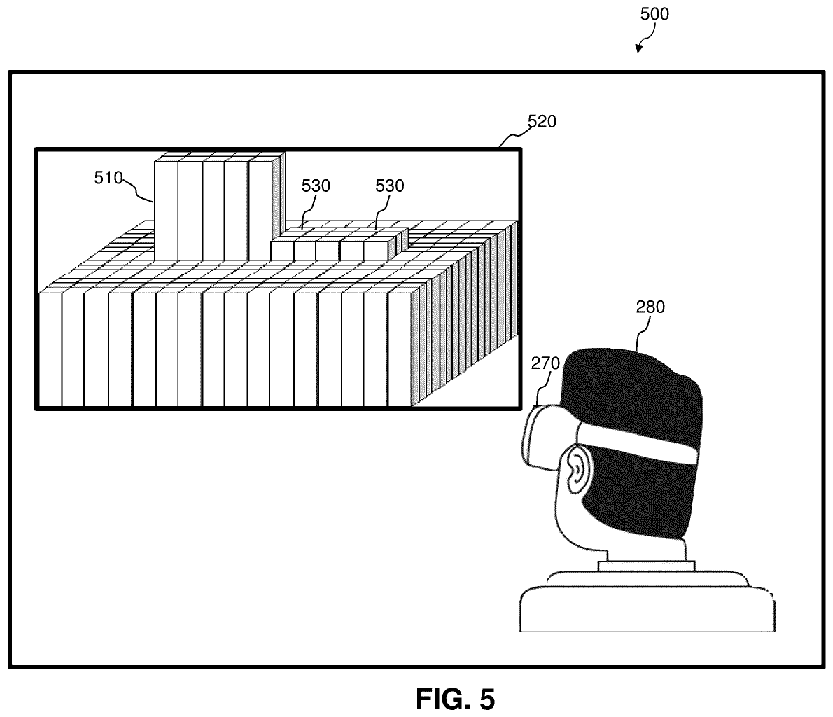

Referring now to FIG. 5, an AR experience 500 comprising a virtual object model 510 of the virtual object presented to computing device 270 is depicted, according to an exemplary embodiment. As illustrated, model generation module 360 generates virtual object model 510 based on object detection module 350 identifying the virtual object within the applicable frame, in which virtual object model 510 is outlined with a highlighted outlining 520 applied by virtual interaction module 390 based upon detection of one or more virtual interactions associated with user 280. In some embodiments, highlighted outlining 520 is applied to one or more edges of virtual object model 510 allowing sensory unit module 370 to allocate the sensory units along the one or more edges; however, sensory unit module 370 may allocate the sensory units to other various surfaces and parts of virtual object model 510 subject to where user 280 may apply virtual interactions and/or physically touch virtual object model 510 from various angles. Each of the sensory units are associated with an applicable sensor of sensor system module 310 and configured to receive virtual interactions resulting in a reaction at the level of the location of the sensory unit, in which reactions may include but are not limited to zooming in, zooming out, shaking, electrification, or any other applicable AR reaction known to those of ordinary skill in the art. In selected embodiments, the sensory units provide a personalized assistance for visually impaired users to not only navigate the virtual environment, but also interact with virtual objects in various manners. For example, sensory unit module 370 applies one or more rules to the sensory units allowing correlation between sensory units, virtual interactions, reactions, and the like in a manner personalized for user 280, which may be supported via a reinforcement learning model operated by machine learning module 320. Thus, personalized feedback such as feedback and heuristics associated with user 280 specify which virtual interactions, reactions, etc. apply to sensory units. In addition, visual, haptic, and/or auditory feedback may be utilized to allow sensory unit module 370 to specify how sensory units are allocated on virtual object model 510, in which machine learning models operated by machine learning module 320 may be used to ascertain instances in which there is a high probability of user 280 getting lost or misdirected within the virtual object and/or virtual environment due to reactions of sensory units.

User 280 may also provide virtual interactions with virtual object model 510 at a granular level in which zooming in and zooming out functions are applied to virtual object model 510 allowing the optimal aid to user 280 in navigating the virtual environment. For example, user 280 may zoom out of the current view of virtual object model 510 to the point where virtual object model 510 is shrunk to a size where it can be held in the hands of user 280 within the virtual environment resulting in user 280 being able to simultaneously view virtual object model 510 along with the remainder of the virtual environment. Furthermore, as user 280 is interacting with virtual object model 510 textual data and annotations associated with virtual object model 510 derived from one or more of database 220, augmented reality module database 240, object modeling module database 260 may be presented to user 280.

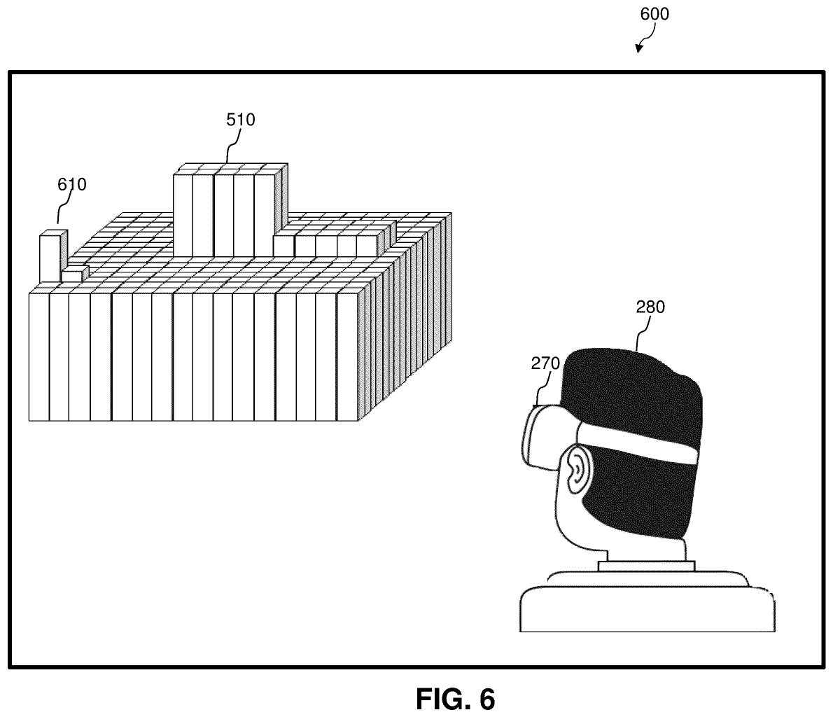

Referring now to FIG. 6, an AR experience 600 comprising virtual object model 510 and a thumbnail 610 generated by thumbnail module 380 presented to computing device 270 is depicted, according to an exemplary embodiment. Thumbnail 610 is configured to be a representation of the applicable portion of the AR experience within the currently parsed frame including the applicable virtual object associated with virtual object model 510; however, thumbnail 610 may include multiple virtual objects that are subject to interactions with user 280 allowing user 280 to apply AR commands configured to be received at the applicable sensors associated with the sensory unit selected by user 280. Once a virtual object model in thumbnail 610 is selected (e.g., receives touch, gestures, voice commands, etc.), the corresponding sensory unit for the applicable frame will notify user 280, and vice versa. In other words, virtual interaction with a sensory unit of virtual object model 510 initiates notification or any other applicable reaction associated with the sensory unit in addition to thumbnail 610. For example, if user 280 touches a virtual object and/or virtual element of thumbnail 610, the corresponding sensory unit for the whole frame associated with thumbnail 610? will be shaken. In some embodiments, thumbnail module 380 supports user 280 applying virtual interactions to thumbnail 610 and virtual object model 510 simultaneously at a granular in which level user 280 may hold thumbnail 610 in one hand and virtual object model 510 in the other hand within the virtual environment.

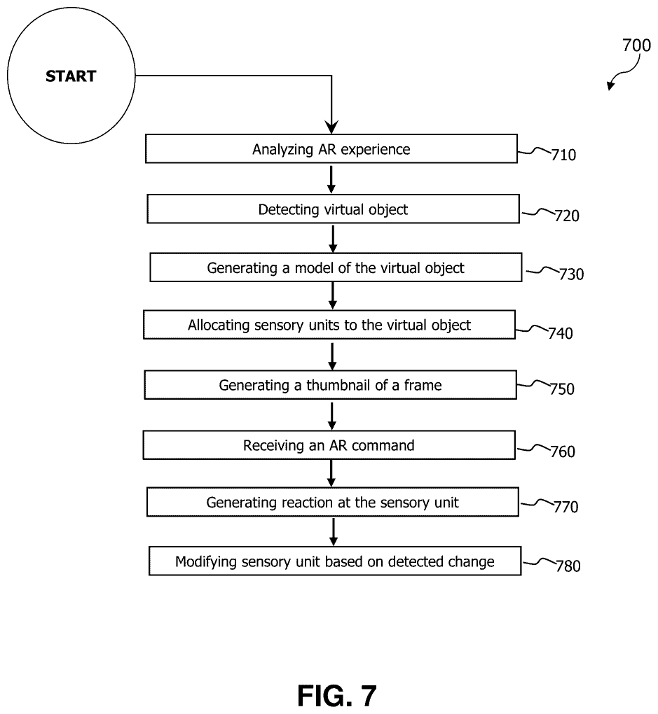

With the foregoing overview of the example architecture, it may be helpful now to consider a high-level discussion of an example process. FIG. 7 depicts a flowchart illustrating a computer-implemented process 700 for a method for augmented reality (AR) visual impairment assistance, consistent with an illustrative embodiment. Process 700 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 710 of process 700, AR experience analyzer 340 analyzes the augmented reality experience being presented to user 280 on computing device 270. AR experience analyzer 340 may continuously parse the AR experience into a plurality of frames for the purpose of optimizing analysis and identification of virtual objects within virtual environments associated with the AR experience of user 280. In addition to faster and more efficient virtual object detection, frame-by-frame analysis allows for various types of data to be ascertained from the applicable frame along with sensor data derived from sensor system module 310 including, but not limited to, virtual environment context, virtual object proximity from user 280 within virtual environment, virtual object metadata (e.g., type, shape, color, etc.), or any other applicable augmented reality-based data known to those of ordinary skill in the art.

At step 720 of process 700, object detection module 350 identifies one or more virtual objects within the virtual environment and/or frames. In some embodiments, object detection module 350 identifies the virtual objects utilizing cognitive systems, image detection techniques, etc. Machine learning module 320 may utilize reinforcement learning models in order to assist object detection module 350 with identifying virtual objects, in which the models utilize artificial intelligence machine learning techniques to perform classification on the virtual objects. In some embodiments, reinforcement learning models may be generated based on the sensor data derived from sensor system module 310 and user-specified distance preference information provided to the centralized platform by user 280 in order to generate tactile output for guiding user 280 through the virtual environment by specifying minimum distance measures to detected virtual objects within the virtual environment.

At step 730 of process 700, model generation module 360 generates a virtual object model of the virtual objects identified by object detection module 350. Model generation module 360 generates a model of multi-dimensional virtual objects in the virtual environment by using 3D reconstruction data derived from AR experience analyzer module 340 (e.g., images, video stream, sensor data, etc.) and object detection module 350 in order to generate a 3D point cloud of the virtual object. The 3D point cloud may be used for tracking in AR application hosted by the centralized platform, by matching points from the cloud to regions in the live video or other applicable sensor data associated with the virtual environment and frames thereof. In some embodiments, the virtual object models may be modified based on a detected change in the AR experience such as user 280 changing frames in which a virtual object is desired to be viewed/interacted with.

At step 740 of process 700, sensory unit module 370 allocates the sensory units to the virtual object model generated by model generation module 360. Each of the sensory units are associated with a sensor associated with sensor system module 310, in which the sensors are configured to receive AR commands in the form of virtual interactions applied by user 280. AR commands may include but are not limited to user pressing the sensory unit in the virtual environment, voice commands (e.g., zoom in, zoom out, etc.), AR gestures (e.g., swiping motion, pinching motion, head nod, etc.), or any other applicable augmented reality-based virtual interaction with virtual objects and/or environments known to those of ordinary skill in the art. In some embodiments, sensory unit module 370 may modify the allocation, applied rules, virtual interactions, reactions, and the like associated with sensory units based on various factors such as, but not limited to, changing of the viewing direction of user 280, updates to augmented reality-based data, and the like.

At step 750 of process 700, thumbnail module 380 generates the thumbnails derived from the frames associated with the AR experience. Thumbnails are configured to be interacted with at the same time as virtual object models allowing visually impaired users the opportunity to view, manipulate, and/or interact with the aforementioned in a personalized manner without getting lost orientation-wise within the virtual environment. Thumbnail module 380 supports user 280 applying virtual interactions to thumbnails and virtual object models simultaneously at a granular level in which user 280 may hold a thumbnail in one hand and virtual object model in the other hand while applying AR commands to the respective virtual elements within the virtual environment.

At step 760 of process 700, AR commands are received by the applicable sensors of the sensory units. Based upon the received AR command, virtual interaction module 390 determines the applicable virtual interaction to be applied to the sensory units of the virtual object models; however, in some instances a sensory threshold is applied to the sensory units, in which the virtual interaction does not initiate the applicable reaction unless the sensory threshold is exceeded. For example, user 280 performing a swiping motion across multiple sensory units may indicate that user 280 is experiencing difficulty interacting with the virtual object model preventing the sensory threshold from being exceeded; thus, the swiping motion is ignored and no reaction occurs. In another example, user 280 provides an AR command in the form of the utterance “zoom in” in the direction of the applicable sensor associated with the applicable sensory unit resulting in not only a reaction of zooming in on the associated location, but also a reading out of what is currently being viewed by user 280 in the zoomed-in state in order to assist the visually impaired user.

At step 770 of process 700, virtual interaction module 390 generates the reaction at the location of the sensory unit. A reaction may include, but is not limited to, movement, zooming in, zooming out, shaking, electrification, reading out of virtual object information (e.g., location, color, context, etc.), accessing of augmented reality module database 240, and the like. In some embodiments, virtual interaction module 390 may apply a highlighting feature to a virtual object model based upon the applicable virtual interaction received at the applicable sensory unit, in which the edges of the virtual object are highlighted. Upon the edges being highlighted, the reactions may be applied to the highlighted edges enticing the attention of user 280 along with providing user 280 the opportunity to interact with the applicable sensory unit(s) in the vicinity of the highlighted edges.

At step 780 of process 700, sensory unit module 370 modifies the allocation of the sensory units of a virtual object module based upon a detected change. In some embodiments, the detected change may result in a change to the virtual object model overall which may include the allocation of one or more sensory units and/or the rules applied to the sensory units (e.g., sensory threshold, triggering AR command, reaction, etc.). A detected change may include but is not limited to a change in pressure applied in a pressing motion of user 280 on a virtual element, modification of a virtual object and/or virtual element in the virtual environment (e.g., vibrating or shaking action applied to a virtual object), change of orientation of user 280, and the like.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for augmented reality (AR) visual impairment assistance, the method comprising:
analyzing, by a computing device, an AR experience of a user;
detecting, by the computing device, at least one virtual object based on the analysis;
generating, by the computing device, a model of the at least one virtual object;
receiving, by the computing device, an AR command of the user; and
modifying, by the computing device, the model based on the AR command.

2. The computer-implemented method of claim 1, wherein generating the model comprises:
highlighting, by the computing device, the edge of the at least one virtual object; and
allocating, by the computing device, a plurality of sensory units to the at least one virtual object.

3. The computer-implemented method of claim 2, wherein the highlighting of the edge is rendered by the plurality of sensory units and the plurality of sensory units are configured to receive the AR command.

4. The computer-implemented method of claim 1, wherein the AR command is associated with at least one virtual interaction with the virtual object.

5. The computer-implemented method of claim 4, wherein the at least one virtual interaction initiates a virtual object reaction comprising one or more of zooming in, zooming out, shaking, and electrification.

6. The computer-implemented method of claim 2, further comprising:
modifying, by the computing device, the plurality of sensory units based on a detected change to the AR experience.

7. The computer-implemented method of claim 1, wherein generating the model further comprises:
generating, by the computing device, an interactive thumbnail associated with the AR experience;
wherein the interactive thumbnail and virtual object are designed to be inserted in the respective hands of the user.

8. A computer program product for augmented reality (AR) visual impairment assistance, the computer program product comprising one or more computer readable storage media and program instructions collectively stored on the one or more computer readable storage media, the stored program instructions comprising:
program instructions to analyze an AR experience of a user;
program instructions to detect at least one virtual object based on the analysis;
program instructions to generate a model of the at least one virtual object;
program instructions to receive an AR command of the user; and
program instructions modify the model based on the AR command.

9. The computer program product of claim 8, wherein program instructions to generate the model comprise:
program instructions to highlight the edge of the at least one virtual object; and
program instructions to allocate a plurality of sensory units to the at least one virtual object.

10. The computer program product of claim 8, wherein the AR command is associated with at least one virtual interaction with the virtual object.

11. The computer program product of claim 9, wherein the highlighting of the edge is rendered by the plurality of sensory units and the plurality of sensory units are configured to receive the AR command.

12. The computer program product of claim 10, wherein the at least one virtual interaction initiates a virtual object reaction comprising one or more of zooming in, zooming out, shaking, and electrification.

13. The computer program product of claim 9, further comprising:
program instructions to modify the plurality of sensory units based on a detected change to the AR experience.

14. The computer program product of claim 8, wherein program instructions to generate the model further comprise:
program instructions to generate an interactive thumbnail associated with the AR experience;
wherein the interactive thumbnail and virtual object are designed to be inserted in the respective hands of the user.

15. A computer system for augmented reality (AR) visual impairment assistance, the computer system comprising:
one or more processors;
one or more computer-readable memories;
program instructions stored on at least one of the one or more computer-readable memories for execution by at least one of the one or more processors, the program instructions comprising:
program instructions to analyze an AR experience of a user;
program instructions to detect at least one virtual object based on the analysis;
program instructions to generate a model of the at least one virtual object;
program instructions to receive an AR command of the user; and
program instructions to modify the model based on the AR command.

16. The computer system of claim 15, wherein program instructions to generate the model comprise:
program instructions to highlight the edge of the at least one virtual object; and
program instructions to allocate a plurality of sensory units to the at least one virtual object.

17. The computer system of claim 15, wherein the AR command is associated with at least one virtual interaction with the virtual object.

18. The computer system of claim 17, wherein the at least one virtual interaction initiates a virtual object reaction comprising one or more of zooming in, zooming out, shaking, and electrification.

19. The computer system of claim 16, further comprising:
program instructions to modify the plurality of sensory units based on a detected change to the AR experience.

20. The computer-implemented method of claim 1, wherein program instructions to generate the model further comprise:
program instructions to generate an interactive thumbnail associated with the AR experience;
wherein the interactive thumbnail and virtual object are designed to be inserted in the respective hands of the user.
